(19) United States
(12) Patent Application Publication
(10) Pub. No.: US 2026/0094945 A1
(43) Pub. Date: Apr. 2, 2026

(54) BATTERY

(71) Applicant: HONDA MOTOR CO., LTD., Tokyo (JP)

(72) Inventors: Yuya Tabuchi, Tokyo (JP); Shunichiro Sueyoshi, Tokyo (JP); Atsuhiro Higashino, Tokyo (JP); Junichi Izawa, Tokyo (JP); Shoji Nitta, Tokyo (JP)

(21) Appl. No.: 19/339,384

(22) Filed: Sep. 25, 2025

(30) Foreign Application Priority Data
Sep. 30, 2024 (JP) 2024-171374

(51) Int. Cl. H01M 50/503; H01M 50/213; H01M 50/258; H01M 50/507

(52) U.S. Cl. CPC H01M 50/503; H01M 50/213; H01M 50/258; H01M 50/507

(57) ABSTRACT

This battery includes a battery module that is disposed inside a housing, includes a plurality of battery cells, and has a plurality of side surfaces oriented in different directions and a component that is electrically connected to the battery module, in which the battery module and the component are connected by a plurality of bus bars, and each of the plurality of bus bars are disposed on different side surfaces of the battery module and passes between the side surface on which the bus bars are disposed and the housing.

### CROSS-REFERENCE TO RELATED APPLICATION

The present application claims priority based on Japanese Patent Application No. 2024-171374, filed Sep. 30, 2024, the content of which is incorporated herein by reference.

### BACKGROUND OF THE INVENTION

### Field of the Invention

The present invention relates to a battery.

### Description of Related Art

In recent years, research and development has been conducted into batteries that contribute to energy efficiency to ensure that more people have access to affordable, reliable, sustainable and advanced energy.

For example, a battery in which different battery modules are stacked in one direction within a housing and a control unit is disposed on a top of them is known (for example, refer to European Patent Application, Publication No. 4199173).

### SUMMARY OF THE INVENTION

In a technology related to batteries, for example, a bus bar that electrically connects battery modules stacked in one direction is disposed between the battery modules and the housing. With this battery, when a side wall of the housing is recessed inward, there is a possibility that the housing and the bus bar may come into contact with each other.

To solve the problem described above, an aspect of the present invention aims to prevent bus bars from coming into contact with each other through a housing when the side wall of the housing is recessed inward. This will ultimately contribute to improving energy efficiency.

To achieve the object described above, a battery according to an aspect of the present invention have adopted the following configuration.

(1) According to one aspect of the present invention, a battery includes a battery module (for example, a first battery module 25 in the embodiment) that is disposed inside a housing (for example, a battery case 12 in the embodiment), includes a plurality of battery cells (for example, cells 32 in the embodiment), and has a plurality of side surfaces (for example, side surfaces 61a to 61d in the embodiment) oriented in different directions, and a component (for example, a control unit 18 in the embodiment) that is electrically connected to the battery module, in which the battery module and the component are connected by a plurality of bus bars (for example, third bus bars 57 in the embodiment), and the plurality of bus bars are disposed on different side surfaces (for example, a first side surface 61a and a third side surface 61c in the embodiment) of the battery module and passes between the side surface on which the bus bars are disposed and the housing.

According to the aspect of (1) described above, the battery module and the component can be connected using the plurality of bus bars. These bus bars may be disposed on different side surfaces of the battery module. Therefore, these bus bars can be disposed at distant positions from each other by ensuring a large distance between these bus bars. This makes it possible to prevent the bus bars from coming into contact with each other via the housing when the housing is recessed inward. This makes it possible to prevent the bus bars from coming into contact with each other via the housing when the housing is recessed inward.

(2) In the aspect of (1) described above, a plurality of battery modules (for example, a first battery module 25 and a second battery module 26 in the embodiment) obtained by adding another battery module (for example, the second battery module 26 in the embodiment) to the battery module may be stacked, the component may be disposed on one side or the other side of the plurality of battery modules, and may have a connection bus bar (for example, a second bus bar 56 in the embodiment) that electrically connects the plurality of battery modules, and the bus bar may be routed from the battery module (for example, the first battery module 25 in the embodiment) positioned on the component side among the plurality of battery modules.

According to the aspect of (2) described above, the plurality of battery modules are stacked in a vertical direction and electrically connected using a connection bus bar. Among the plurality of battery modules, a bus bar is routed from the battery module positioned on the component side to the component. Therefore, it is possible to perform connection from the battery module close to the component to the component using the bus bar. This makes it possible to shorten a length of the bus bar and reduce costs compared to when the bus bar is used to connect the battery module farthest from the component to the component.

(3) In the aspect of (2) described above, the connection bus bar may connect the battery modules in a bent state, and a bent portion (for example, a bent portion 56a in the embodiment) of the connection bus bar may be exposed in a direction in which a surface (for example, a second side surface 61b in the embodiment) of the side surfaces different from a surface through which the bus bar passes (for example, a first side surface 61a and a third side surface 61c in the embodiment) is oriented.

According to the aspect of (3) described above, the bent portion of the connection bus bar is exposed in a direction in which the surface of the side surfaces different from the surface through which the bus bar passes is oriented. This allows the connection bus bar and the bus bar to be disposed at distant positions from each other. In other words, when the housing is recessed inward, it is possible to prevent contact between the connection bus bar and the bus bar via the housing. This makes it possible to prevent electrical contact between the connection bus bar and the bus bar when the housing is recessed inward.

(4) In the aspect of (2) described above, the battery cell may include a first end (for example, a first end 32a in the embodiment) and a second end (for example a second end 32b in the embodiment) which are both ends in a predetermined direction, and a positive electrode terminal (for example, a positive electrode terminal 32P in the embodiment) and a negative electrode terminal (for example, a negative electrode terminal 32N in the embodiment) disposed on the first end side, the plurality of battery cells in each of the battery modules may be electrically connected to each other by an inter-cell connection bus bar (for example, a first bus bar 55 in the embodiment), the first ends of the plurality of battery cells in the battery module (for example, the first battery module 25 in the embodiment) and the first ends of the plurality of battery cells in the other battery module (for example, the second battery module 26 in the embodiment) may be disposed at positions facing each other, and the connection bus bar may also be disposed between the plurality of battery modules.

According to the aspect of (4) described above, the first ends of the plurality of battery cells of one battery module and the first ends of the plurality of battery cells of another battery module are disposed at positions facing each other in the vertical direction, and a connection bus bar is disposed between the battery modules. Therefore, it is possible to perform connection of battery cells of each battery module and connections between the plurality of battery modules at positions where the plurality of battery modules face each other.

As a result, it is possible to concentrate connection between battery cells of each battery module and battery modules at positions where the battery modules face each other.

(5) In the aspect of (1) described above, the battery modules may include a battery cell and a cell holder (for example, a first cell holder unit 31 in the embodiment) that holds the battery cell and forms the side surfaces (for example, a first side surface 61a and a third side surface 61c in the embodiment), the cell holder may have a pair of protruding portions (for example, protruding portions 66 and 68 in the embodiment) that protrude outward from the side surfaces (for example, the first side surface 61a and the third side surface 61c in the embodiment), and the bus bar may pass between the protruding portions.

According to the aspect of (5) described above, the bus bar may pass between the pair of protruding portions. Therefore, this makes it easier to fix the bus bar at a predetermined position using the pair of protruding portions on the side surfaces of the cell holder. As a result, for example, when the battery vibrates or the like, the pair of protruding portions can prevent vibration of the bus bar passing through the side surface.

(6) In the aspect of (5) described above, the protruding portion may have a protruding height in a direction from the side surface (for example, the first side surface 61a or the third side surface 61c in the embodiment) toward the housing, which is greater than a thickness of the bus bar.

According to the aspect of (6) described above, the protruding height of the protruding portion is made higher than the thickness of the bus bar. Therefore, when the housing is recessed inward, the protruding portion can come into contact with the housing before the bus bar does. This makes it possible to prevent the housing and the bus bar from coming into contact using the protruding portion.

According to the aspects of the present invention, when the housing is recessed inward, it is possible to prevent contact between the bus bars via the housing.

### BRIEF DESCRIPTION OF THE DRAWINGS

FIG. 1 is a perspective view of a battery in an embodiment of the present invention.

FIG. 2 is an exploded perspective view which shows the battery of FIG. 1.

FIG. 3 is a cross-sectional view taken along line III-III in FIG. 2.

FIG. 4 is a perspective view which shows a first battery module in the embodiment when it is attached to a bottom case.

FIG. 5 is a perspective view of a first cell holder unit in the embodiment, as viewed from above.

FIG. 6 is a plan view which shows a first cell holder unit in the embodiment.

FIG. 7 is a cross-sectional view of a first battery module in the embodiment.

FIG. 8 is a perspective view of the first battery module and a second battery module in the embodiment when they are expanded, as viewed from a bottom surface side.

### DESCRIPTION OF EMBODIMENTS

Hereinafter, a battery according to one embodiment of the present invention will be described with reference to the drawings.

### Battery

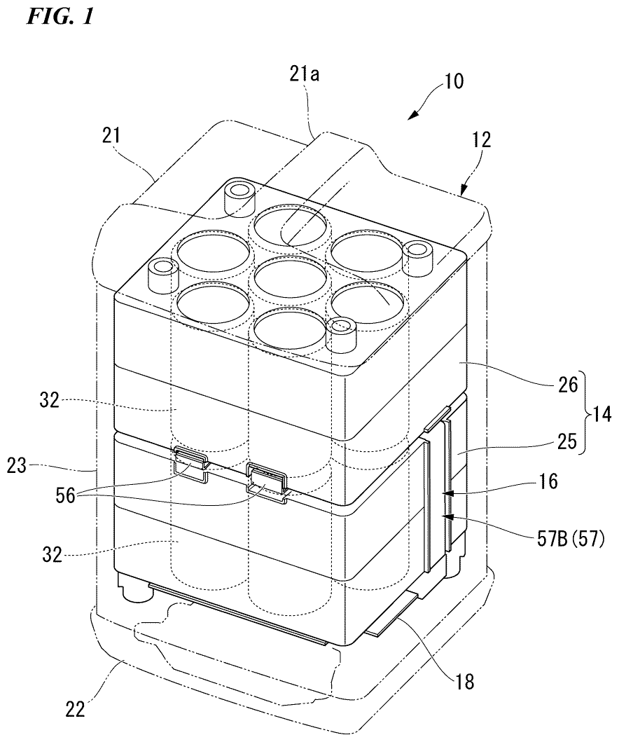

FIG. 1 is a perspective view of a battery according to the embodiment.

As shown in FIG. 1, the battery 10 is configured to be detachable from, for example, various electric power devices. The electric power devices from which the battery 10 is detachable include, for example, electric vehicles, electric mobile objects, electric machines, power supply devices, and various electric devices. The electric vehicles include, for example, electric cars equipped with a rotating electric machine driven by power of the battery 10 as a power source, saddle-type vehicles, and kick scooters, hybrid vehicles that combine a rotating electric machine and an internal combustion engine, and fuel battery vehicles that combine the battery 10 and a fuel battery. The electric mobile objects include, for example, robots, aircraft, and mobile objects on and under water. The electric machines are, for example, construction machines equipped with a rotating electric machine as a power source. The power supply device is, for example, a stationary or mobile power supply device that discharges and charges the battery 10.

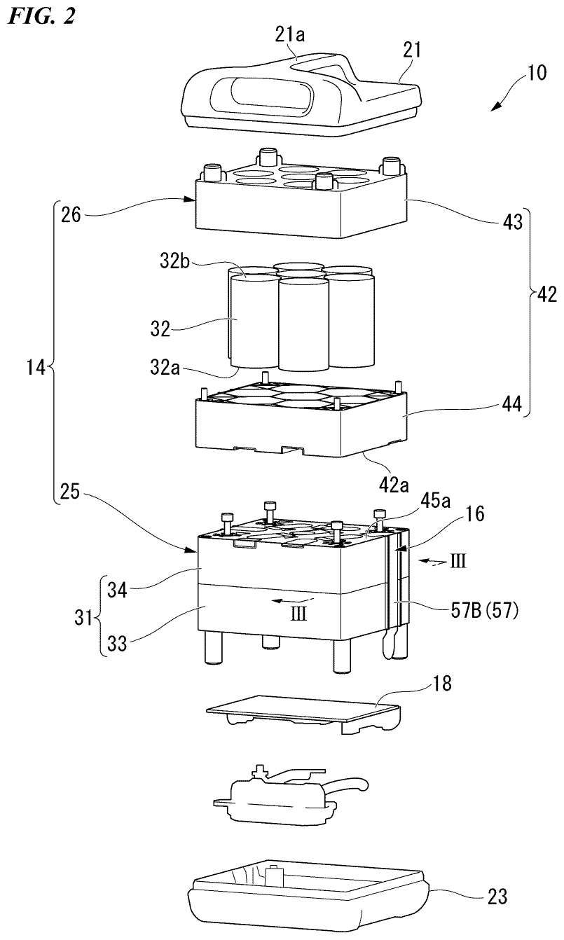

FIG. 2 is an exploded perspective view which shows the battery in FIG. 1.

As shown in FIGS. 1 and 2, an outer shape of the battery 10 is, for example, a box-like shape with a handle 21a on a top case 21 which will be described below. The battery 10 is a so-called cassette-type battery pack (secondary battery) that is configured to be replaceable. The battery 10 includes, for example, a battery case (housing) 12, a battery module unit 14, a bus bar unit 16, and a control unit (component) 18.

### battery Case

The battery case 12 includes the top case 21, a bottom case 22, and a middle case 23. An outer shape of each of the top case 21 and the bottom case 22 is, for example, an open box shape. An outer shape of the middle case 23 is, for example, a cylindrical shape. The top case 21 and the bottom case 22 close both open ends in an axial direction along a central axis of the middle case 23.

In the following, a top case 21 side of the battery 10 will be described as an “upper side” and a bottom case 22 side as a “lower side.” A direction of a surface orthogonal to a vertical direction will be described as a “planar direction.” The vertical direction may also be referred to as an “orthogonal direction” orthogonal to the planar direction.

In the embodiment, an orientation of the battery 10 will be described using the top case 21 on the upper side and the bottom case 22 on the lower side, but the orientation of the battery 10 can be selected arbitrarily.

### battery Module Unit

The battery module unit 14 is disposed inside the battery case 12 (specifically, the middle case 23). The battery module unit 14 includes, for example, a first battery module (battery module) 25 and a second battery module (another battery module) 26.

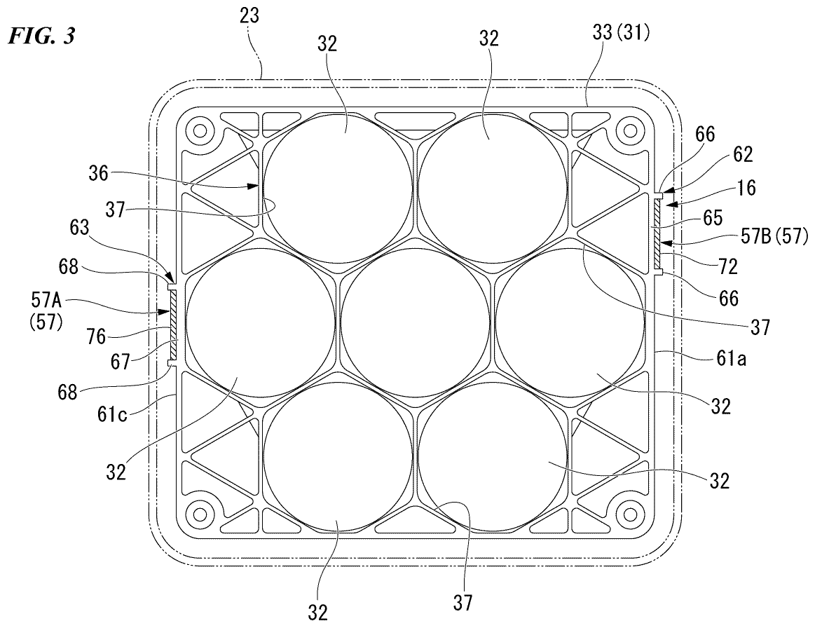

FIG. 3 is a cross-sectional view taken along line III-III in FIG. 2.

As shown in FIGS. 2 and 3, the first battery module 25 includes, for example, a first cell holder unit (cell holder) 31 and a plurality of cells (battery cells) 32. The first cell holder unit 31 includes a first cell holder 33 and a second cell holder 34. In the first cell holder unit 31, the first cell holder 33 and the second cell holder 34 are stacked in order from the bottom case 22 to an upper side. The first cell holder unit 31 holds a plurality of cells 32 (described below) by housing them therein.

The first cell holder unit 31 is configured as a honeycomb structure 36 by, for example, the first cell holder 33 and the second cell holder 34. The honeycomb structure 36 has a plurality of housing portions 37 arranged in an array. The housing portions 37 have walls formed in a polygonal shape when viewed in an orthogonal direction, for example. In the embodiment, a regular hexagon is used as an example of the polygon. That is, the housing portion 37 is formed, for example, as a hollow regular hexagonal column. Note that the shape of the polygon is not limited to a regular hexagon and can be selected arbitrarily. The housing portions 37 are disposed with their axes facing a vertical direction.

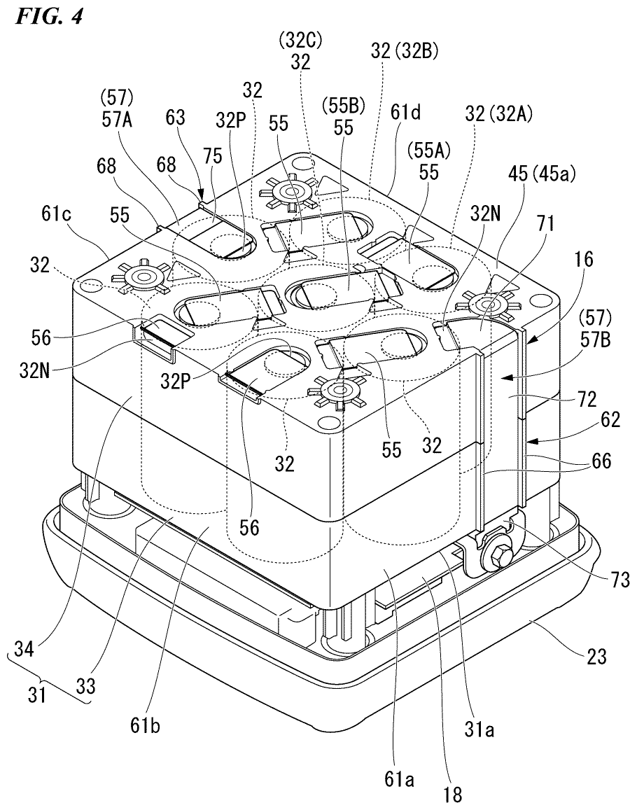

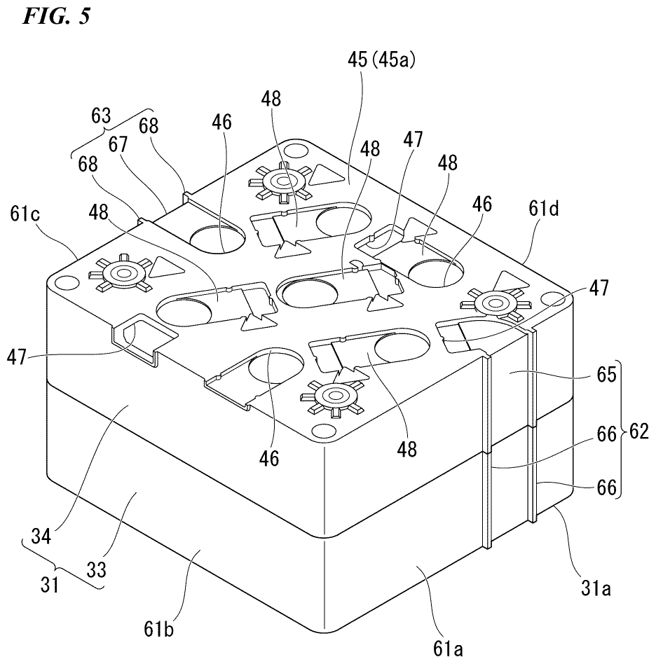

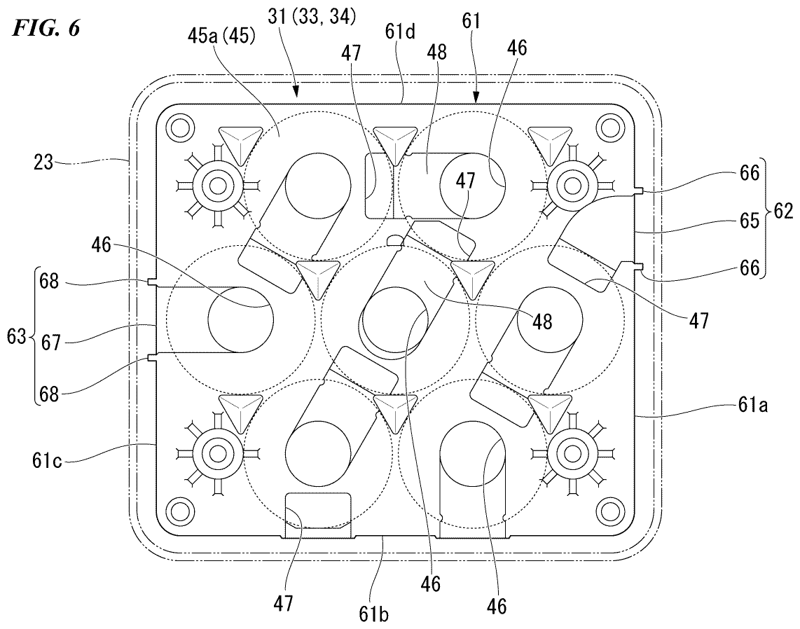

FIG. 4 is a perspective view which shows the first battery module when it is attached to the bottom case. FIG. 5 is a perspective view of the first cell holder unit from an upper side. FIG. 6 is a plan view which shows the first cell holder unit.

As shown in FIGS. 4 to 6, the first cell holder unit 31 has an outer portion 61, a first routing guide 62, and a second routing guide 63. The outer portion 61 has, for example, a plurality of side surfaces. The plurality of side surfaces include a bottom surface 45a, a first side surface 61a, a second side surface 61b, a third side surface 61c, and a fourth side surface 61d.

The bottom surface 45a is formed on an upper surface of the first cell holder unit 31 (specifically, an upper surface of the bottom portion 45 of the second cell holder 34 which will be described below). The first side surface 61a, the second side surface 61b, the third side surface 61c, and the fourth side surface 61d are formed from each side of the bottom surface 45a to the lower side. The first side surface 61a, the second side surface 61b, the third side surface 61c, and the fourth side surface 61d are formed in order, for example, in a clockwise direction. Therefore, the plurality of side surfaces such as the bottom surface 45a, the first side surface 61a, the second side surface 61b, the third side surface 61c, and the fourth side surface 61d are oriented in different directions. The number and shape of the plurality of side surfaces can be selected arbitrarily.

The first routing guide 62 is provided near the fourth side surface 61d on the first side surface 61a. The first routing guide 62 extends to the lower side in a strip shape, for example, from the bottom portion 45 along the first side surface 61a to a lower end 31a of the first cell holder unit 31. The first routing guide 62 has a guide surface 65 and a pair of protruding portions 66.

The guide surface 65 is formed flush with respect to, for example, the first side surface 61a. The pair of protruding portions 66 are provided along both sides of the guide surface 65. The pair of protruding portions 66 protrude outward from the first side surface 61a toward a side wall of the middle case 23. The pair of protruding portions 66 have a height of protruding from the first side surface 61a toward the side wall of the middle case 23, which is greater than a thickness of the third bus bar 57B which will be described below.

The second routing guide 63 is provided in a center between the second side surface 61b and the fourth side surface 61d on the third side surface 61c. The second routing guide 63 extends to the lower side in a strip shape from the bottom portion 45 along the third side surface 61c to the lower end 31a of the first cell holder unit 31. The second routing guide 63 has a guide surface 67 and a pair of protruding portions 68. The guide surface 67 is formed, for example, flush with respect to the third side surface 61c. The pair of protruding portions 68 are provided along both sides of the guide surface 67. The pair of protruding portions 68 protrude outward from the third side surface 61c to the side wall of the middle case 23. The pair of protruding portions 68 have a height of protruding from the third side surface 61c toward the side wall of the middle case 23, which is greater than a thickness of a third bus bar 57A, which will be described below.

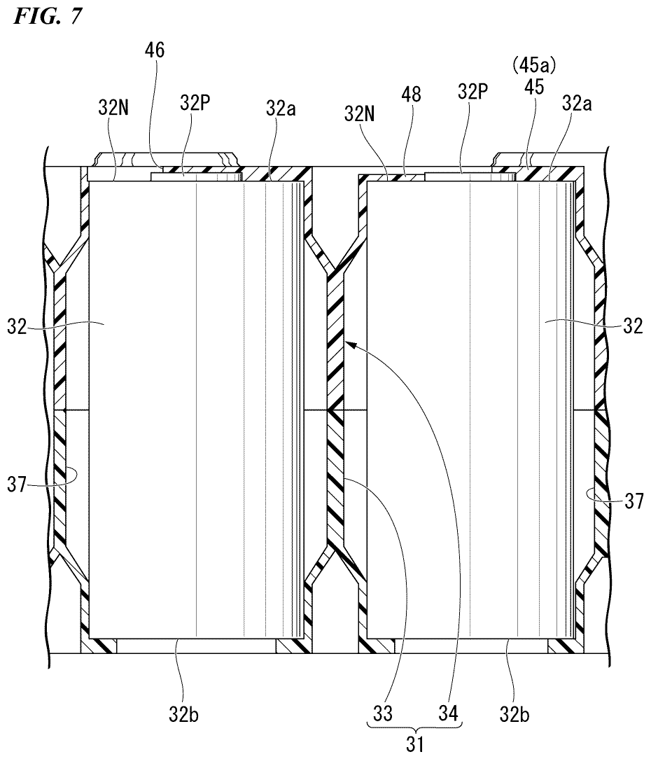

FIG. 7 is a cross-sectional view of the first battery module.

As shown in FIGS. 5 and 7, the second cell holder 34 has a bottom portion 45, a positive electrode hole 46, a negative electrode hole 47, and a contact portion 48. The bottom portion 45 is formed at a top portion of the second cell holder 34. The bottom surface 45a of the first cell holder unit 31 is formed on the upper surface of the bottom portion 45.

The positive electrode hole 46 penetrates the bottom portion 45 in a thickness direction (that is, a vertical direction). The positive electrode hole 46 exposes a positive electrode terminal 32P (which will be described below) of the cell 32 in the thickness direction. The negative electrode hole 47 penetrates the bottom portion 45 in the thickness direction. The negative electrode hole 47 exposes the negative electrode terminal 32N (which will be described below) of the cell 32 in the thickness direction. The abutment portion 48 abuts against a first bus bar 55 (which will be described below).

As shown in FIGS. 3 and 7, the cell 32 is disposed (housed) in the vertical direction along an axial direction of the housing portion 37 inside the housing portion 37. The cell 32 is formed in a cylindrical shape. The cell 32 includes a first end 32a, a second end 32b, a positive electrode terminal 32P, and a negative electrode terminal 32N. The first end 32a and the second end 32b are provided at both ends in the vertical direction (a predetermined direction).

Specifically, the first end 32a is provided at an upper end of the cell 32. The second end 32b is provided at a lower end of the cell 32. Therefore, the plurality of cells 32 are disposed along a predetermined surface (for example, the bottom surface 45a) with orientations of the first end 32a and the second end 32b aligned. The positive electrode terminal 32P and the negative electrode terminal 32N are disposed (provided) on a first end 32a side.

That is, the positive electrode terminal 32P and the negative electrode terminal 32N are formed on the upper side of the cell 32. Therefore, when the cells 32 are arranged in a planar direction, the positive electrode terminal 32P and the negative electrode terminal 32N are provided on the upper side of the cells 32. The positive electrode terminal 32P protrudes upward from the negative electrode terminal 32N and is positioned above the negative electrode terminal 32N in the orthogonal direction.

The positive electrode terminal 32P is exposed to an outside of the second cell holder 34 through the positive electrode hole 46 (refer to FIG. 5). The negative electrode terminal 32N is exposed to the outside of the second cell holder 34 through the negative electrode hole 47 (refer to FIG. 5).

As shown in FIG. 1 and FIG. 2, the second battery module 26 is stacked on the upper side of the first battery module 25. The first battery module 25 and the second battery module 26 are formed, for example, generally symmetrically in the vertical direction. The second battery module 26 includes, for example, a second cell holder unit (cell holder) 42 and a plurality of cells 32. The second cell holder unit 42 includes a third cell holder 43 and a fourth cell holder 44. In the second cell holder unit 42, the third cell holder 43 and the fourth cell holder 44 are stacked in order from the top case 21 downward.

As shown in FIGS. 2 and 7, the second cell holder unit 42 has a bottom surface 42a similar to the bottom surface 45a of the first cell holder unit 31. The bottom surface 45a of the first battery module 25 and the bottom surface 42a of the second battery module 26 are disposed at positions facing each other in the vertical direction. The second cell holder unit 42 is held by housing the plurality of cells 32 in the second cell holder unit 42, similar to the first battery module 25. The plurality of cells 32 housed in the second cell holder unit 42 are disposed along a predetermined surface (for example, the bottom surface 42a) with the orientations of the first end 32a and the second end 32b aligned. The plurality of cells 32 housed in the second cell holder unit 42 have the first ends 32a disposed on the lower side.

Here, the bottom surface 45a of the first battery module 25 and the bottom surface 42a of the second battery module 26 are disposed at positions facing each other in the vertical direction. Therefore, the first end 32a of the cell 32 in the first battery module 25 and the first end 32a of the cell 32 in the second battery module 26 are disposed at positions facing each other in the vertical direction, for example.

The plurality of cells 32 housed in the second cell holder unit 42 have positive electrode terminals 32P and negative electrode terminals 32N (both not shown) disposed (provided) on the lower side. The positive electrode terminal 32P protrudes downward from the negative electrode terminal 32N and is positioned below the negative electrode terminal 32N in the orthogonal direction. Therefore, the positive electrode terminal 32P and the negative electrode terminal 32N of the cell 32 in the first battery module 25 and the positive electrode terminal 32P and the negative electrode terminal 32N of the cell 32 in the second battery module 26 are disposed at, for example, positions facing each other in the vertical direction.

In the embodiment, the first battery module 25 and the second battery module 26 are used as an example of the battery module unit 14, but the number of battery modules can be selected arbitrarily.

### bus Bar Unit

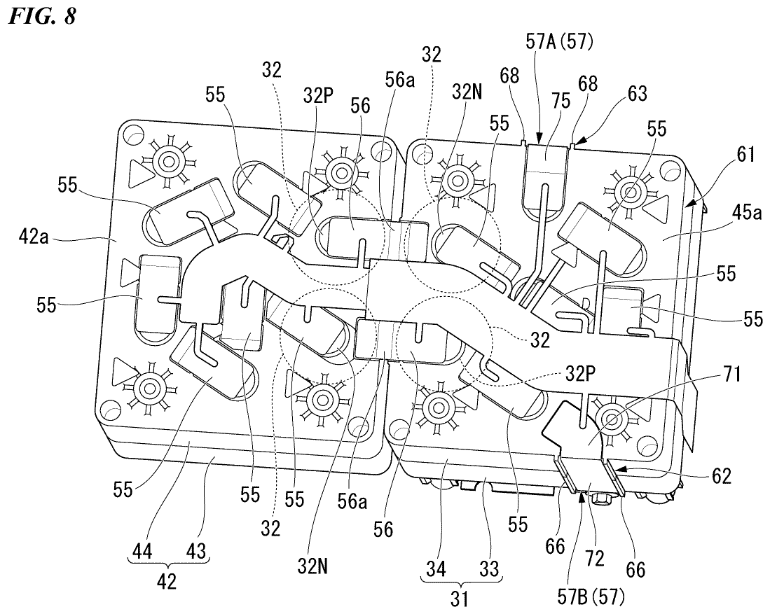

FIG. 8 is a perspective view of the first battery module and the second battery module when they are expanded, as viewed from the bottom surface side.

As shown in FIGS. 4, 7 and 8, the bus bar unit 16 is provided in the first battery module 25 and the second battery module 26 (refer to FIG. 2). The bus bar unit 16 includes a plurality of first bus bars (inter-cell connection bus bars) 55, a plurality of second bus bars (connection bus bars) 56, and a plurality of third bus bars 57 (bus bars).

In the embodiment, for example, two second bus bars 56 will be described as an example of the plurality of second bus bars 56. The number of second bus bars 56 can be selected arbitrarily according to the number of first battery modules 25 and second battery modules 26. Furthermore, two third bus bars 57 will be described as an example of the plurality of third bus bars 57. The number of third bus bars 57 can be selected arbitrarily according to the number of control units 18 (described below).

The plurality of first bus bars 55 are included in the first battery module 25 and the second battery module 26. The first bus bar 55 of the first battery module 25 electrically connects the plurality of cells 32 included in the first battery module 25. Hereinafter, “electrically connect” may be referred to as “connect. ”

The plurality of first bus bars 55 connect an electrode of one cell 32 to an electrode of another cell 32 adjacent to the one cell 32 in the first battery module 25. The electrode of one cell 32 is one of electrodes of the positive electrode terminal 32P and the negative electrode terminal 32N of the one cell 32. The electrode of the other cell 32 is an electrode of the other of the positive electrode terminal 32P and the negative electrode terminal 32N of the other cell 32. In other words, the first bus bar 55 electrically connects adjacent cells 32 to each other. The plurality of first bus bars 55 are disposed on the bottom surface 45a of the first battery module 25.

In addition, in the second battery module 26, the plurality of first bus bars 55 electrically connect adjacent cells 32 to each other, similar to the first battery module 25.

Here, the plurality of first bus bars 55 are disposed on the bottom surface 45a of the first battery module 25 and the bottom surface 42a of the second battery module 26.

As shown in FIG. 8, the two second bus bars 56 electrically connect, for example, the cell 32 of the first battery module 25 and the cell 32 of the second battery module 26. Here, the positive electrode terminal 32P and the negative electrode terminal 32N of the cell 32 in the first battery module 25 and the positive electrode terminal 32P and the negative electrode terminal 32N of the cell 32 in the second battery module 26 are disposed at, for example, positions facing each other in the vertical direction.

In this state, one of the two second bus bars 56 is connected to, for example, the positive electrode terminal 32P of the cell 32 in the first battery module 25. Moreover, one of the second bus bars 56 is connected to, for example, the negative electrode terminal 32N of the cell 32 in the second battery module 26. Furthermore, the other of the two second bus bars 56 is connected to, for example, the negative electrode terminal 32N of the cell 32 in the first battery module 25. The other second bus bar 56 is connected to the positive electrode terminal 32P of the cell 32 in the second battery module 26.

Therefore, the cell 32 of the first battery module 25 and the cell 32 of the second battery module 26 are electrically connected to each other by the two second bus bars 56.

Here, the two second bus bars 56 are disposed on the bottom surface 45a of the first battery module 25 and the bottom surface 42a of the second battery module 26. In addition, the bottom surface 45a of the first battery module 25 and the bottom surface 42a of the second battery module 26 are disposed at positions facing each other. Therefore, the two second bus bars 56 are disposed in a bent state between the first battery module 25 and the second battery module 26. Bent portions 56a of the two second bus bars 56 are exposed in a direction in which the second side surface 61b (refer to FIG. 6) is oriented.

As shown in FIGS. 3 and 4, the two third bus bars 57 electrically connect the first battery module 25 and the second battery module 26 to the control unit 18 (described below). The two third bus bars 57 are configured from a positive electrode bus bar 57A and a negative electrode bus bar 57B. Here, the control unit 18 is disposed on a lower side of the first battery module 25.

The negative electrode bus bar 57B is formed, for example, in a strip shape. The negative electrode bus bar 57B has an upper end 71, an extension portion 72, and a lower end 73. The upper end 71 is connected to the negative electrode terminal 32N of the cell 32 in the first battery module 25. The upper end 71 is disposed on the bottom surface 45a of the first battery module 25. The extension portion 72 is bent downward from the upper end 71.

The extension portion 72 is routed to pass between the pair of protruding portions 66 along the guide surface 65 of the first routing guide portion 62. The pair of protruding portions 66 have a height of protruding from the first side surface 61a toward the side wall of the middle case 23, which is greater than the thickness of the third bus bar 57B. The extension portion 72 extends downward to the lower end 31a of the first cell holder unit 31 and is disposed on the first side surface 61a of the first battery module 25. The lower end 73 protrudes downward from the lower end 31a of the first cell holder unit 31 and connects to the negative electrode terminal (not shown) of the control unit 18.

In other words, the negative electrode bus bar 57B, when connected to the negative electrode terminal 32N of the cell 32 in the first battery module 25, is routed along the first routing guide 62 and connected to the negative electrode terminal (not shown) of the control unit 18.

In this manner, the negative electrode bus bar 57B is routed from the first battery module 25, which is positioned on the control unit 18 side, of the first battery module 25 and the second battery module 26.

The positive electrode bus bar 57A is formed in a strip shape, for example, similar to the negative electrode bus bar 57B. The positive electrode bus bar 57A has an upper end 75, an extension portion 76, and a lower end (not shown). The upper end 75 is connected to the positive electrode terminal 32P of the cell 32 in the first battery module 25. The upper end 75 is disposed on the bottom surface 45a of the first battery module 25. The extension portion 76 is bent downward from the upper end 75.

The extension portion 76 is routed to pass between the pair of protruding portions 68 along the guide surface 67 of the second routing guide 63. The pair of protruding portions 68 have a height of protruding from the third side surface 61c toward the side wall of the middle case 23, which is greater than a thickness of the third bus bar 57A. The extension portion 76 extends downward to the lower end 31a of the first cell holder unit 31 and is disposed on the third side surface 61c of the first battery module 25. The lower end protrudes downward from the lower end 31a of the first cell holder unit 31 and is connected to the positive electrode terminal (not shown) of the control unit 18.

In other words, the positive electrode bus bar 57A, when connected to the positive electrode terminal 32P of the cell 32 in the first battery module 25, is routed along the second routing guide portion 63 and connected to the positive electrode terminal (not shown) of the control unit 18.

In this manner, the positive electrode bus bar 57A is routed from the first battery module 25, which is positioned on the control unit 18 side, of the first battery module 25 and the second battery module 26.

The cell 32 of the first battery module 25 and the cell 32 of the second battery module 26 are electrically connected by two second bus bars 56 (also refer to FIG. 8). Therefore, the cell 32 of the first battery module 25 and the cell 32 of the second battery module 26 are electrically connected to the control unit 18 by the positive electrode bus bar 57A and the negative electrode bus bar 57B.

In addition, the extension portion 76 of the positive electrode bus bar 57A is disposed on the third side surface 61c of the first battery module 25. The extension portion 72 of the negative electrode bus bar 57B is disposed on the first side surface 61a of the first battery module 25. Therefore, the extension portion 76 of the positive electrode bus bar 57A and the extension portion 72 of the negative electrode bus bar 57B are disposed on different side surfaces of the first battery module 25 (that is, the third side surface 61c and the first side surface 61a). Therefore, the extension portions 76 and 72 pass through a surface (that is, the third side surface 61c and the first side surface 61a) different from the second side surface 61b where the bent portions 56a of the two second bus bars 56 are exposed.

Moreover, the extension portion 76 of the positive electrode bus bar 57A is disposed to pass between the third side surface 61c and the side wall of the middle case 23. The extension portion 72 of the negative electrode bus bar 57B is disposed to pass between the first side surface 61a and the side wall of the middle case 23.

Furthermore, the plurality of first bus bars 55 are disposed on the bottom surface 45a of the first battery module 25 and the bottom surface 42a of the second battery module 26 (refer to FIG. 8). Furthermore, the two second bus bars 56 are disposed on the bottom surface 45a of the first battery module 25 and the bottom surface 42a of the second battery module 26 (refer to FIG. 8).

The third side surface 61c through which the extension portion 76 of the positive electrode bus bar 57A passes is disposed at a different position relative to the bottom surface 45a on a side on which the plurality of first bus bars 55 and the two second bus bars 56 are disposed. The first side surface 61a through which the extension portion 72 of the negative electrode bus bar 57B passes is disposed at a different position relative to the bottom surface 45a on the side on which the plurality of first bus bars 55 and the two second bus bars 56 are disposed.

In the embodiment, an example in which the extension portion 76 of the positive electrode bus bar 57A is disposed on the third side surface 61c and the extension portion 72 of the negative electrode bus bar 57B is disposed on the first side surface 61a will be described, but the present invention is not limited to this. As another example, the extension portion 76 of the positive electrode bus bar 57A and the extension portion 72 of the negative electrode bus bar 57B may be disposed on different side surfaces.

### Control Unit

As shown in FIGS. 2 and 4, the control unit 18 is disposed on the lower side (the other side) of the first battery module 25. The control unit 18 is, for example, a so-called battery management unit (BMU). The control unit 18 monitors and controls states of the cell 32 of the first battery module 25 and the cell 32 of the second battery module 26. The control unit 18 is, for example, a software function unit that functions by a processor such as a central processing unit (CPU) executing a predetermined program.

The software function unit is an electronic control unit (ECU) that includes a processor such as a CPU, a read only memory (ROM) that stores a program, a random access memory (RAM) that temporarily stores data, and electronic circuits such as a timer. At least a part of the control unit 18 may be an integrated circuit such as large scale integration (LSI).

The control unit 18 includes, for example, various sensors that detect states of the cell 32 of the first battery module 25 and the cell 32 of the second battery module 26, and a storage unit that stores information on the battery 10, a predetermined program, and the like.

The states of the cells 32 of the first battery module 25 and the cells 32 of the second battery module 26 are, for example, a voltage, a current, a temperature, and the like. The information on the battery 10 includes, for example, identification information such as a battery ID (IDentifier) exclusively assigned to the battery 10, information on the states of the cells 32 based on a manufacturing date and time, an initial state capacity, an output of a sensor, and the like, charge and discharge history, storage time in a replacement unit, and usage pattern history.

In the embodiment, an example in which the control unit 18 is disposed on the lower side (other side) of the first battery module 25 will be described, but the present invention is not limited to this. As another example, the control unit 18 may be disposed on an upper side (one side) of the second battery module 26.

According to the battery 10 according to the embodiment described above, as shown in FIGS. 3 and 4, the extension portion 76 of the positive electrode bus bar 57A and the extension portion 72 of the negative electrode bus bar 57B are disposed on the third side surface 61c and the first side surface 61a, which are different from each other, of the first battery module 25. Therefore, a distance between the positive electrode bus bar 57A and the negative electrode bus bar 57B is secured large, and the positive electrode bus bar 57A and the negative electrode bus bar 57B can be disposed at distant positions.

This makes it possible to prevent the positive electrode bus bar 57A and the negative electrode bus bar 57B from coming into contact with each other through the side wall of the middle case 23 when the side wall of the middle case 23 is recessed inward. Therefore, it is possible to prevent the positive electrode bus bar 57A and the negative electrode bus bar 57B from coming into contact with each other via the middle case 23 when the side wall of the middle case 23 is recessed.

In addition, the first battery module 25 and the second battery module 26 are stacked vertically and electrically connected by two second bus bars 56. Furthermore, the positive electrode bus bar 57A and the negative electrode bus bar 57B are wired from the first battery module 25 positioned on a control unit 18 side to the control unit 18. Therefore, the first battery module 25 close to the control unit 18 can be connected to the control unit 18 using the positive electrode bus bar 57A and the negative electrode bus bar 57B.

This makes it possible to shorten a length of the positive electrode bus bar 57A and the negative electrode bus bar 57B compared to a case where the second battery module 26 farther from the control unit 18 is connected to the control unit 18 using the positive electrode bus bar 57A and the negative electrode bus bar 57B. Therefore, cost of the positive electrode bus bar 57A and the negative electrode bus bar 57B can be reduced.

Furthermore, as shown in FIGS. 3, 4 and 8, the plurality of first bus bars 55 and the two second bus bars 56 are disposed on the bottom surface 42a and bottom surface 45a. The bottom surface 42a and the bottom surface 45a are disposed at positions different from the third side surface 61c through which the extension portion 76 of the positive electrode bus bar 57A passes. The bottom surface 42a and the bottom surface 45a are disposed at positions different from the first side surface 61a through which the extension portion 72 of the negative electrode bus bar 57B passes. Furthermore, the bent portions 56a where the two second bus bars 56 are bent are exposed to the second side surface 61b different from the third side surface 61c and the first side surface 61a. Therefore, the plurality of first bus bars 55 and the two second bus bars 56 can be positioned at positions distant from the positive electrode bus bar 57A and the negative electrode bus bar 57B.

This makes it possible to prevent the plurality of first bus bars 55 and the two second bus bars 56 from coming into contact with the positive electrode bus bar 57A and the negative electrode bus bar 57B via the sidewall of the middle case 23 when the sidewall of the middle case 23 is recessed inward. Therefore, it is possible to prevent the plurality of first bus bars 55 and the two second bus bars 56 from coming into electrical contact with the positive electrode bus bar 57A and the negative electrode bus bar 57B when the sidewall of the middle case 23 is recessed inward.

In addition, the first battery module 25 and the second battery module 26 are disposed at positions facing each other in the vertical direction, and the two second bus bars 56 are disposed between each of the battery modules 25 and 26. Therefore, it is possible to perform connection of the cells 32 of each of the battery modules 25 and 26 and connection between each of the battery modules 25 and 26 at positions where the first battery module 25 and the second battery module 26 face each other.

This allows the connection of the cell 32 of the first battery module 25 and the cell 32 of the second battery module 26, and the connection between each of the battery modules 25 and 26 to be concentrated at positions where the first battery module 25 and the second battery module 26 face each other.

Furthermore, the extension portion 76 of the positive electrode bus bar 57A is routed to pass between the pair of protruding portions 68 in the second routing guide 63. Therefore, this makes it easier to fix the positive electrode bus bar 57A at a predetermined position using the pair of protruding portions 68. Moreover, the extension portion 72 of the negative electrode bus bar 57B is routed to pass between the pair of protruding portions 66 in the first routing guide 62. This makes it easier to fix the negative electrode bus bar 57B at a predetermined position using the pair of protruding portions 66.

As a result, for example, when the battery 10 vibrates, or the like, the pair of protruding portions 68 can prevent vibration of the positive electrode bus bar 57A, and the pair of protruding portions 66 can prevent vibration of the negative electrode bus bar 57B.

In addition, a protruding height of the pair of protruding portions 66 in the first routing guide 62 is made higher than a thickness of the negative electrode bus bar 57B. Therefore, when the side wall of the middle case 23 is recessed inward, the pair of protruding portions can come into contact with the side wall of the middle case 23 before the negative electrode bus bar 57B. As a result, the pair of protruding portions 66 can prevent the side wall of the middle case 23 and the negative electrode bus bar 57B from coming into contact.

Furthermore, a protruding height of the pair of protruding portions 66 in the second routing guide 63 is made higher than a thickness of the positive electrode bus bar 57A. Therefore, when the side wall of the middle case 23 is recessed inward, the pair of protruding portions 66 can come into contact with the side wall of the middle case 23 before the positive electrode bus bar 57A. As a result, the pair of protruding portions 66 can prevent the side wall of the middle case 23 and the positive electrode bus bar 57A from coming into contact.

Therefore, when the side wall of the middle case 23 is recessed inward, the positive electrode bus bar 57A and the negative electrode bus bar 57B can be more easily fixed at predetermined positions.

A technical scope of the present invention is not limited to the embodiment described above, and various modifications can be made within a range not departing from the gist of the present invention.

In addition, components in the embodiment described above can be replaced with well-known components as appropriate within a range not departing from the gist of the present invention, and the modified examples described above can be combined as appropriate.

### BRIEF DESCRIPTION OF THE REFERENCE SYMBOLS

10 Battery
12 Battery case (Housing)
18 Control unit (Component)
25 First battery module (Battery module)
26 Second battery module (Another battery module)
31 First cell holder unit (cell holder)
32 Cell (Battery cell)
32a First end
32b Second end
32P Positive electrode terminal
32N Negative electrode terminal
42 Second Cell Holder Unit
42a, 45a Bottom surface (Surface on a side where connection bus bar is disposed, predetermined surface)
45a, 61a to 61d A plurality of side surfaces
55 First bus bar (Inter-cell connection bus bar)
56 Second bus bar (Connection bus bar)
57 Third bus bar (Bus bar)
61a First side surface (Different side surface of battery module, surface through which bus bar passes)
61b Second side surface (Surface different from surface through which bus bar passes)
61c Third side surface (Different side surface of battery module, surface through which bus bar passes)
66, 68 Protruding portion

What is claimed is:

1. A battery comprising:
a battery module that is disposed inside a housing, includes a plurality of battery cells, and has a plurality of side surfaces oriented in different directions; and
a component that is electrically connected to the battery module,
wherein the battery module and the component are connected by a plurality of bus bar, and
each of the plurality of bus bars are disposed on different side surfaces of the battery module and passes between the side surface on which the bus bars are disposed and the housing.

2. The battery according to claim 1,
wherein a plurality of battery modules obtained by adding another battery module to the battery module are stacked,
the component is disposed on one side or the other side of the plurality of battery modules, and has a connection bus bar that electrically connects the plurality of battery modules, and
the bus bar is routed from the battery module positioned on the component side among the plurality of battery modules.

3. The battery according to claim 2,
wherein the connection bus bar connects the battery modules in a bent state, and
a bent portion of the connection bus bar is exposed in a direction in which a surface of the side surfaces different from a surface through which the bus bar passes is oriented.

4. The battery according to claim 2,
wherein the battery cell includes
a first end and a second end) which are both ends in a predetermined direction, and
a positive electrode terminal and a negative electrode terminal disposed on the first end side,
the plurality of battery cells in each of the battery modules are electrically connected to each other by an inter-cell connection bus bar, the first ends of the plurality of battery cells in the battery module and the first ends of the plurality of battery cells in the other battery module are disposed at positions facing each other, and
the connection bus bar is disposed between the plurality of battery modules.

5. The battery according to claim 1,
wherein the battery modules include a battery cell and a cell holder that holds the battery cell and forms the side surfaces,
the cell holder has a pair of protruding portions that protrude outward from the side surfaces, and
the bus bar passes between the protruding portions.

6. The battery according to claim 5,
wherein the protruding portions have a height of protruding in a direction from the side surfaces toward the housing, which is greater than a thickness of the bus bar.
